(19) United States
(12) Patent Application Publication
(10) Pub. No.: US 2007/0127343 A1
(43) Pub. Date: Jun. 7, 2007

(54) INFORMATION RECORDING DEVICE AND RELATED METHOD

(76) Inventors: Wei-Hsiang Tseng, Taipei City (TW); Jin-Bin Yang, Changhua County (TW); Hsin-Cheng Chen, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,749

(22) Filed: Dec. 5, 2005

(51) Int. Cl. G11B 7/0045

(52) U.S. Cl. 369/59.12

(57) ABSTRACT

An information recording device and related method are disclosed. The information recording device is capable of adjusting a phase difference between a first synchronization signal and a second synchronization signal. The information recording device includes an encoder for generating a run-length of an encoded data; a phase detector for detecting the phase difference between the first and the second synchronous signals; a shift offset controller, electrically connected to the phase detector, for generating a shift information according to the phase difference; and a write pulse generator, electrically connected to the encoder and the shift offset controller, for generating a write pulse signal according to the run-length of the encoded data and the shift information, thereby making the first synchronous signal synchronized with the second synchronous signal.

### BACKGROUND

The invention relates to an information recording device and a related method, and more particularly, to an information recording device and a related method capable of adjusting the phase difference between two synchronization signals by adjusting the write pulse signal for recording a recording medium.

For several years, optical disc drives are utilized to record information onto optical discs or to read information stored on the optical discs. In the related arts, optical disc drives are designed to read or write data upon different kinds of optical discs, such as compact disc (CD) and digital versatile disc (DVD). In addition, except for some write once optical disc e.g. CD-R and DVD-R, the optical disc drives are capable of rewriting data onto certain optical discs e.g. CD-RW and DVD-RW.

To adequately manage data, the storage region of an optical disc is fragmented into many small frames. The optical disc also has a storage format that must be determined before the data is recorded onto an optical disc. An optical disc drive ascertains the storage format of the optical disc in advance of recording data onto the optical disc. The storage format references additional frame information, for example, Absolute Time in Pre-groove (ATIP) for CD specification or Address In Pre-groove (ADIP) for DVD.

Since a series of data is recorded onto an optical disc as a plurality of data sets, it is an important issue to record a data set into an expected location of the data set. Take CD drive for example, the optical disc recording device compares a phase of a synchronization signal “Async” (ATIP Synchronous) with a phase of a synchronization signal “Esync” (Encoder Subcode Synchronous). The synchronization signal “Async” is periodically added to absolute-location information (i.e., the ATIP signal) that indicates the absolute location on the optical disc. The synchronization signal “Esync” is periodically added to the data to be written onto the optical disc. If a phase difference between the synchronization signal “Async” and the synchronization signal “Esync” is greater than a threshold value then the data may be recorded onto a wrong location.

The U.S. Pat. No. 6,795,384 discloses a method for solving the problem mentioned above. The related art utilizes a phase adjusting unit to determine the phase difference between the synchronization signals “Async” and “Esync” that allows the phase adjusting unit to control the rotational speed of the optical disc. Since the rotational speed of the optical disc changes, the scanning speed of the optical disc also changes which resulting in the acceleration or deceleration of the synchronization signal “Async”. Therefore, the phase difference between the synchronization signals “Async” and “Esync” is eliminated accordingly. In the same manner, related art is capable of controlling the operation timing of a plurality of encoded data sets, so as to adjust the written speed of data patterns corresponding to the encoded data sets. Since either the written speed of the data patterns corresponding to the encoded data sets is adjusted or the scanning speed of the optical disc is adjusted, the phase difference is eliminated accordingly.

Please refer to FIG. 1. FIG. 1 is a functional block diagram of an optical disc drive 100 according to the related art. The optical disc drive 100 comprises a pick-up head 3, a reproducing circuit 4, a decoder 5, a timing management unit 6, an encoder 7, a pick-up head driving unit 8, a buffer memory 9, a buffer management unit 10, a synchronization detecting unit 11, a phase adjusting unit 13, and a Voltage Control Oscillator (VCO) 14. The buffer memory 9 controlled by the buffer management unit 10 stores the data transmitted from a host device, and transmits a plurality of data sets to the encoder 7. The encoder 7 encodes the data sets and then outputs encoded data sets to the pick-up head driving unit 8 according to a clock signal generated by the VCO 14, and the encoder 7 also outputs the synchronization signal Esync to the phase adjusting unit 13. Please note that the clock signal relates to the operation timing mentioned above. Finally, the encoded data sets are recorded onto an optical disc by the pick-up head 3. After an RF signal corresponding to the recorded encoded data sets is read back by the pick-up head 3, the reproducing circuit 4 determines the ATIP information according to the RF signal. Next, the synchronization detecting unit 11 determines the synchronization signal “Async” according to the ATIP information. Finally, the phase adjusting unit 13 generates a control signal by comparing the synchronization signal “Async” with the synchronization signal “Esync”, so as to control the VCO 14. After the clock signal generated by the VCO 14 is adjusted according to the control signal, the phase difference between the synchronization signals “Async” and “Esync” is reduced.

However, the operation of adjusting the clock signal must be implemented carefully. Otherwise, the phase difference between the synchronization signals “Async” and “Esync” may cause oscillation resulting in the serious faulty adjustment of the phase difference.

### SUMMARY

It is therefore one of the objectives of the claimed disclosure to provide an information recording device and related method to more easily reduce the phase difference.

An information recording device is disclosed. The information recording device is capable of adjusting a phase difference between a first synchronization signal synchronous to a location on a recording medium and a second synchronization signal synchronous to a data pattern to be written onto the recording medium. The information recording device comprises: an encoder for generating a run-length of an encoded data corresponding to the data pattern to be written onto the recording medium; a phase detector for detecting the phase difference between the first synchronous signal and the second synchronous signal; a shift offset controller, electrically connected to the phase detector, for generating a shift information according to the phase difference; and a write pulse generator, electrically connected to the encoder and the shift offset controller, for generating a write pulse signal according to the run-length of the encoded data and the shift information, thereby making the first synchronous signal synchronized with the second synchronous signal.

An information recording method is disclosed. The information recording method is capable of adjusting a phase difference between a first synchronization signal synchronous to a location on a recording medium and a second synchronization signal synchronous to a data pattern to be written onto the recording medium. The information recording method comprises: generating a run-length of an encoded data corresponding to the data pattern to be written onto the recording medium; detecting the phase difference between the first synchronous signal and the second synchronous signal; generating a shift information according to the phase difference; and generating a write pulse signal according to the run-length of the encoded data and the shift information, thereby making the first synchronous signal synchronized with the second synchronous signal.

According to the present disclosure, the write pulse signal is adjusted according to the phase difference between the first and second synchronization signals. Since the second synchronization signal is periodically added to the encoded data, which is utilized for generating the write pulse signals, the second synchronous signal is shifted accordingly. As a result, the phase difference between the first and second synchronization signals is reduced according to the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an optical disc drive according to the related art.

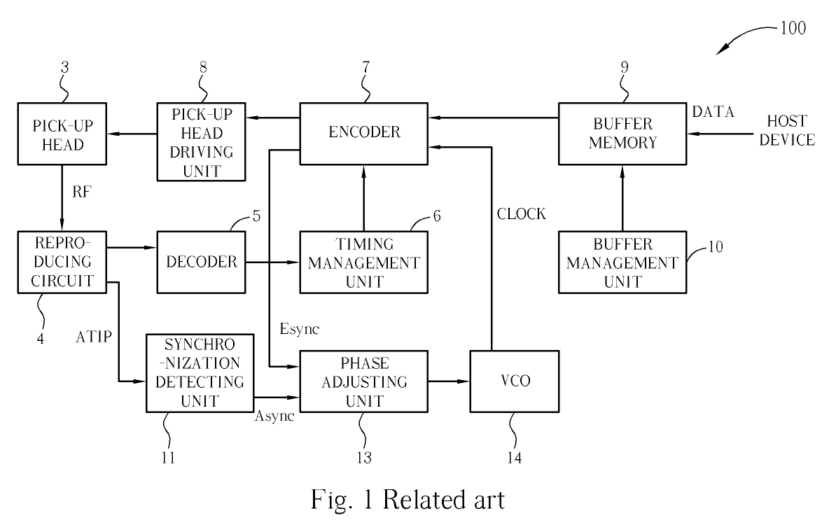

FIG. 2 is a functional block diagram of an information recording device according to a first embodiment.

FIG. 3 is a schematic diagram of a run-length of an encoded data, an original write pulse signal, a delayed write pulse signal, and an advanced write pulse signal.

FIG. 4 is a functional block diagram of the information recording device according to a second embodiment.

FIG. 5 is a schematic diagram of a phase difference between a plurality of run-lengths of the encoded data and the related write pulse signals.

### DETAILED DESCRIPTION

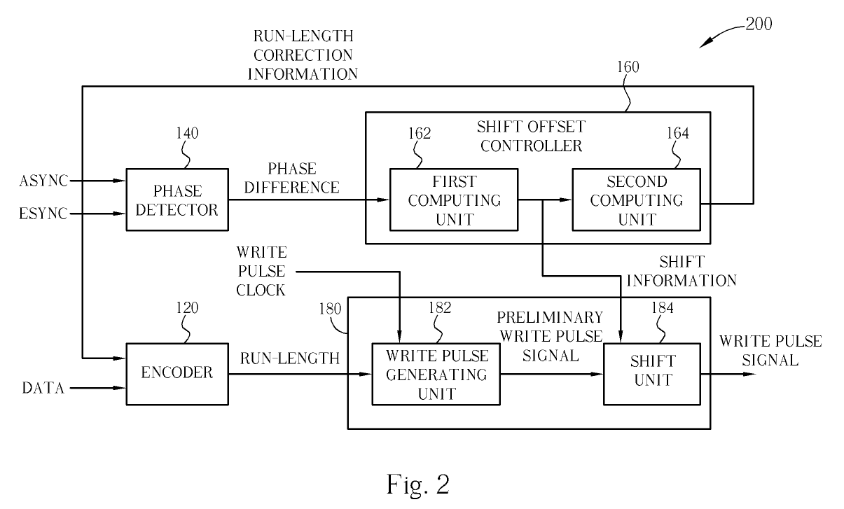

Please refer to FIG. 2. FIG. 2 is a functional block diagram of an information recording device 200 according to a first embodiment. In the first embodiment, the information recording device 200 is an optical disc drive utilized for recording data onto an optical disc. The information recording device 200 comprises an encoder 120, a phase detector 140, a shift offset controller 160, and a write pulse generator 180. As well known, the encoder 120 firstly generates the encoded data by encoding the data to be recorded according to certain encoding schemes. Then the encoder determines the run-length of the encoded data to be kT, where k is an integer and T denotes a cycle of the write clock. The write pulse generator 180 is utilized for generating a write pulse signal according to the run-length of the encoded data and the shift information received from the shift offset controller 160. The phase detector 140 is utilized for detecting the phase difference between the synchronous signals “Async” and “Esync”. After the phase difference reaches a predetermined threshold value, the shift offset controller 160 generates the shift information to the write pulse generator 180. Since the synchronous signal “Esync” is periodically added to the encoded data, which is utilized for generating the write pulse signals, the synchronous signal “Esync” is shifted accordingly. As a result, the phase difference between the synchronous signals “Async” and “Esync” is reduced.

As shown in FIG. 2, the write pulse generator 180 comprises a write pulse generating unit 182 and a shift unit 184. The write pulse generating unit 182 is utilized for generating a preliminary write pulse signal by querying a write strategy table according to the run-length of an encoded data and a write pulse clock, and for transmitting the preliminary write pulse signal to the shift unit 184. If the shift unit 184 receives the shift information, the shift unit 184 will generate the write pulse signal by shifting the preliminary write pulse signal according to the shift information; otherwise, the shift unit 184 will output the write pulse signal equal to the preliminary write pulse signal directly. For example, if the shift information represents a condition that the level transition of the synchronous signal “Async” is earlier than the level transition of the synchronous signal “Esync” by 0.1 T, the shift unit 184 will generate a write pulse signal advancing the preliminary write pulse signal by 0.1 T. In the same manner, if the shift information represents a condition that the level transition of the synchronous signal “Async” is later than the level transition of the synchronous signal “Esync” by 0.1 T, the shift unit 184 will generate a write pulse signal falling behind the preliminary write pulse signal by 0.1 T.

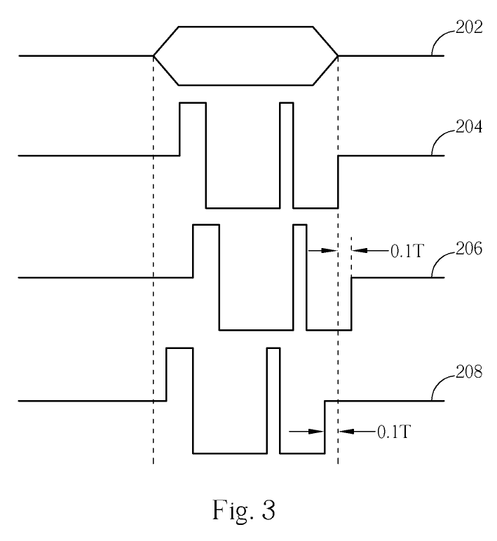

Please refer to FIG. 2 and FIG. 3. FIG. 3 is a schematic diagram of a run-length 202 of an encoded data, three write pulse signal 204, 206, 208. The run-length 202 of an encoded data is the output of the encoder 120, and the write pulse signals 204, 206, 208 are the probable waveform of the write pulse signal outputted from the shift unit 184. If no shift information is received by the shift unit 184, the output of the shift unit 184 is shown as the write pulse signal 204. If the shift information represents that the phase difference between the synchronous signals “Async” and “Esync” reaches 0.1 T, the shift unit 184 will output the write pulse signal 206. If the phase difference between the synchronous signals “Async” and “Esync” reaches −0.1 T, the shift unit 184 will output the write pulse signal 208. It should be noted that the shifting degreed of the write pulse signal is not limited to +−0.1 T according to the present disclosure.

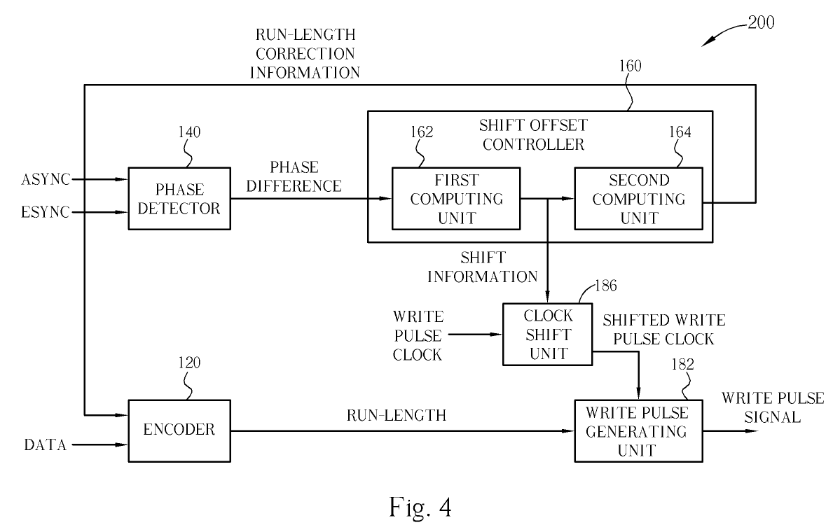

Please refer to FIG. 3 and FIG. 4. FIG. 4 is a functional block diagram of an information recording device 200 according to a second embodiment of the present invention. As shown in FIG. 4, the clock shift unit 186 is a new component applied to shift the write pulse clock according to the shift information, and output the shifted write pulse clock to the write pulse generating unit 182. That means, the write pulse generating unit 182 generates the write pulse signal by querying the write strategy table according to the run-length transmitted form the encoder 120 and the shifted write pulse clock. For example, if the shift information represents that the phase difference between the synchronous signals “Async” and “Esync” reaches 0.1 T, the clock shift unit 186 will delay the write pulse clock by 0.1 T and then the write pulse generating unit 182 will output the write pulse signal 206 accordingly; if the shift information represents that the phase difference between the synchronous signals “Async” and “Esync” reaches −0.1 T, the clock shift unit 186 will advance the write pulse clock by 0.1 T and then the write pulse generating unit 182 will output the write pulse signal 208 accordingly. Since the write strategy table is stored in a pick-up head of the optical disc drive, the write pulse generating unit 182 is located in the pick-up head of the optical disc drive and the clock shift unit 186 is not located in the pick-up head of the optical disc drive. Additionally, since the shift unit 184 shown in FIG. 2 is behind the write pulse generating unit 182, both of them could be located in the pick-up head of the optical disc drive.

Please refer to FIG. 2 again. According to the first embodiment, the shift offset controller 160 comprises a first computing unit 162 and a second computing unit 164. The first computing unit 162 is utilized for generating the shift information when the phase difference between the synchronous signals “Async” and “Esync” reaches a predetermined threshold value, such as 0.1 T or −0.1 T. Consequently, the preliminary write pulse signal is shifted according to the shift information. As the amount of phase shift applied to the preliminary write pulse signal increases, the phase difference between the write pulse signal and the run-length of the encoded data increases. Therefore, a correcting procedure is necessary. The second computing unit 164 is capable of accumulating the amount of phase shift applied to the original write pulse signal according to the shift information. If the amount of phase shift applied to the write pulse signal is approaching a period of the write clock, the second computing unit 164 will generate a correction information outputted to the encoder 120 to adjust the run-length of an encoded data. As a result, phase difference between the write pulse signal and the run-length of the encoded data is reduced. For example, assuming the write pulse signal is shifted by (1/N)T each time, the second computing unit 164 will output a first correction information if the amount of phase shift applied to the write pulse signal is greater than (N−1)/N*T, or the second computing unit 184 will output a second correction information if the amount of phase shift applied to the write pulse signal is less than −(N−1)/N*T. When the first correction information is received, the encoder 120 extends the run-length of the encoded data by 1 T. In the same manner, when the second correction information is received, the encoder 120 shortens the run-length of the encoded data by 1 T. After the encoder 120 adjusts the run-length of the encoded data, the phase difference between the write pulse signal and the run-length of the encoded data decreases.

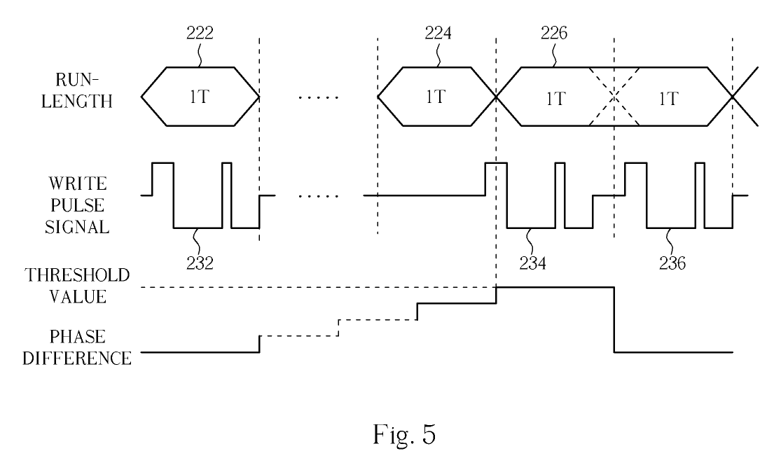

For explaining the correcting procedure in detail, please refer to FIG. 5. FIG. 5 is a schematic diagram of a plurality of run-lengths 222, 224, 226 of the encoded data, the related write pulse signals 232, 234, 236, and the phase difference between the run-lengths 222, 224, 226 of the encoded data and the related write pulse signals 232, 234, 236. The write pulse signal 232 is generated according to the run-length 222; the write pulse signal 234 is generated according to the run-length 224; and the write pulse signal 236 is generated according to the run-length 226. As shown in FIG. 5, the phase difference between the write pulse signal 232 and the run-length 222 (i.e., the amount of phase shifted applied to the write pulse signals) is zero. After a plurality of time interval pass, the phase difference between the write pulse signal 234 and the run-length 224 reaches the threshold value. As a result, the run length 226 is adjusted to alleviate the phase difference between the write pulse signal 236 and the run-length 226. Since the original run-length 226 is equal to 1 T, the run-length 226 is extended to 1+1 T as shown in FIG. 5. In the same manner, if the phase difference between a write pulse signal and the related run-length reaches a negative threshold value, the run-length will be shortened by 1 T, so as to reduce the phase difference between the write pulse signal and the run-length. It should be noted that the type of the run-length is not limited to 1 T as shown in FIG. 5. The run-length of the encoded data changes as the encoded data changes.

Compared with the related art, the present disclosure shifts the write pulse signal to decrease the phase difference between the synchronization signals “Esync” and “Async”, instead of adjusting the writing speed of the data patterns or the spinning speed of the optical disc. Since the synchronization signal “Esync” is periodically added to a series of encoded data corresponding to the write pulse signal, the synchronization signal “Esync” is shifted with the shift of the write pulse signal, so as to reduce the phase difference between the synchronization signals “Esync” and “Async”. Additionally, since the write pulse signal is finely shifted according to the phase difference, the phase difference between the synchronization signals “Esync” and “Async” is reduced smoothly and stably.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information recording device capable of adjusting a phase difference between a first synchronization signal synchronous to a location on a recording medium and a second synchronization signal synchronous to a data pattern to be written onto the recording medium, the information recording device comprising:
an encoder for generating a run-length of an encoded data corresponding to the data pattern to be written onto the recording medium;
a phase detector for detecting the phase difference between the first synchronous signal and the second synchronous signal;
a shift offset controller, electrically connected to the phase detector, for generating a shift information according to the phase difference; and
a write pulse generator, electrically connected to the encoder and the shift offset controller, for generating a write pulse signal according to the run-length of the encoded data and the shift information, thereby making the first synchronous signal synchronized with the second synchronous signal.

2. The information recording device of claim 1, wherein the write pulse generator comprises:
a write pulse generating unit for generating a preliminary write pulse signal by querying a write strategy table according to the run-length of the encoded data and a write pulse clock; and
a shift unit, electrically connected to the write pulse generating unit and the shift offset controller, for generating the write pulse signal by shifting the preliminary write pulse signal according to the shift information;
wherein the preliminary write pulse signal is equal to the write pulse signal if there is no shift information.

3. The information recording device of claim 2, wherein the write pulse generating unit and the shift unit are located in a pick-up head of the information recording device.

4. The information recording device of claim 2, wherein the shift offset controller further comprises:
a first computing unit, electrically connected to the phase detector and the shift unit, for generating the shift information to advance the preliminary write pulse signal by a first predetermined time when the phase difference between the first synchronization signal and the second synchronization signal is greater than a first predetermined threshold value, and for generating the shift information to delay the preliminary write pulse signal by a second predetermined time when the phase difference between the first synchronization signal and the second synchronization signal is less than a second predetermined threshold value.

5. The information recording device of claim 4, wherein the length of the first predetermined time is equal to the length of 1/N cycle of a write clock, the length of the second predetermined time is equal to the length of 1/M cycle of the write clock, where N and M are positive integers.

6. The information recording device of claim 5, wherein M is equal to N.

7. The information recording device of claim 4, wherein the shift offset controller further comprises:
a second computing unit, electrically connected between the encoder and the first computing unit, for computing an amount of phase shift applied to the preliminary write pulse signal according the shift information, for generating a first correction information if the amount of phase shift reaches a third predetermined threshold value, for generating a second correction information if the amount of phase shift reaches a fourth predetermined threshold value, and the second computing unit resetting the amount of phase shift after the first or second correction information is generated;
wherein the encoder adjusts the run-length of the encoded data according to the first correction information or the second correction information.

8. The information recording device of claim 7, wherein after receiving the first correction information, the encoder further extends the run-length of the encoded data by a cycle of a write clock; and after receiving the second correction information, the encoder shortens the run-length of the encoded data by a cycle of the write clock.

9. The information recording device of claim 1, wherein the recording medium is an optical disc.

10. The information recording device of claim 1, wherein the write pulse generator comprises:
a clock shift unit, for shifting a write pulse clock to generate a shifted write pulse clock; and
a write pulse generating unit, electrically connected to the shift unit, for generating the write pulse signal by querying a write strategy table according to the run-length of the encoded data and the shifted write pulse clock.

11. The information recording device of claim 10, wherein the write pulse generating unit is located in a pick-up head of the information recording device.

12. An information recording method capable of adjusting a phase difference between a first synchronization signal synchronous to a location on a recording medium and a second synchronization signal synchronous to a data pattern to be written onto the recording medium, the information recording method comprising:
generating a run-length of an encoded data corresponding to the data pattern to be written onto the recording medium;
detecting the phase difference between the first synchronous signal and the second synchronous signal;
generating a shift information according to the phase difference; and
generating a write pulse signal according to the run-length of the encoded data and the shift information, thereby making the first synchronous signal synchronized with the second synchronous signal.

13. The information recording method of claim 12, wherein the step of generating the write pulse signal comprises:
generating a preliminary write pulse signal by querying a write strategy table according to the run-length of the encoded data and a write pulse clock; and
generating the write pulse signal by shifting the preliminary write pulse signal according to the shift information.

14. The information recording method of claim 13, wherein the step of generating the shift information comprises:
generating the shift information to advance of the write pulse signal by a first predetermined time when the phase difference between the first synchronization signal and the second synchronization signal is greater than a first predetermined threshold value; and
generating the shift information to delay the write pulse signal by a second predetermined time when the phase difference between the first synchronization signal and the second synchronization signal is less than a second predetermined threshold value.

15. The information recording method of claim 14, wherein the length of the first predetermined time is equal to the length of 1/N cycle of a write clock, and the length of the second predetermined time is equal to the length of 1/M cycle of the write clock, where N and M are positive integers.

16. The information recording method of claim 15, wherein M is equal to N.

17. The information recording method of claim 14, further comprising:
computing an amount of phase shift applied to the preliminary write pulse signal according the shift information;
if the amount of phase shift reaches a third predetermined threshold value, generating a first correction information;
if the amount of phase shift reaches a fourth predetermined threshold value, generating a second correction information;
resetting the amount of phase shift after the first or second correction information is generated; and
adjusting the run-length of the encoded data according to the first or second correction information.

18. The information recording method of claim 17, wherein the step of adjusting the run-length of the encoded data comprises:
if the first correction information is generated, extending the run-length of the encoded data by a cycle of a write clock; and
if the second correction information is generated, shortening the run-length of the encoded data by a cycle of the write clock.

19. The information recording method of claim 12, wherein the recording medium is an optical disc.

20. The information recording method of claim 12, wherein the step of generating the write pulse signal comprises:
generating a shifted write pulse clock by shifting a write pulse clock; and
generating the write pulse signal by querying a write strategy table according to the run-length of the encoded data and the shifted write pulse clock.
